(19) United States
(12) Patent Application Publication
(10) Pub. No.: US 2011/0222974 A1
(43) Pub. Date: Sep. 15, 2011

(54) Cutting Insert Having Grooves Formed Between Adjacent Cutting Edges

(75) Inventors: Hong Sik Park, Daegu (KR); Jang Hyuk Joo, Daegu (KR)

(73) Assignee: TaeguTec, Ltd., Dalsung-gun (KR)

(21) Appl. No.: 13/112,633

(22) Filed: May 20, 2011

Related U.S. Application Data
(63) Continuation-in-part of application No. PCT/KR2008/006900, filed on Nov. 21, 2008.

(51) Int. Cl. B23B 27/16; B23B 1/00

(52) U.S. Cl. 407/114; 82/1.11

(57) ABSTRACT

A cutting insert has a structure by which a sufficient surface area is in contact with a tool holder and cutting fluid can be smoothly flowed. The cutting insert has an upper face, a lower face, a plurality of side faces connecting the upper face and the lower face and a through hole passing through the upper face and the lower face, the upper face being divided into a periphery region disposed adjacently to cutting edges formed by the upper face and the side faces, and a central protruded region disposed between the through hole and the periphery region and surrounding the through hole, the central protruded region being placed higher than the edges. The periphery region is formed along all the cutting edges and includes a descent face inclined downward from a given cutting edge to the central protruded region, a bottom face and an ascent face inclined upward from the bottom face to the central protruded region. A plurality of grooves are formed on the central protruded region of the upper face, each groove being formed such that both ends of the groove are directed to adjacent cutting edges.

### Related Applications

This is a Continuation-in-part of international application no. PCT/KR2008/006900, filed Nov. 21, 2008, which published as WO 2010/058870A1. The contents of the aforementioned application are incorporated by reference in their entirety.

### TECHNICAL FIELD

The present invention relates to a cutting insert, more particularly, to a cutting insert having a structure by which cutting heat generated during a cutting machining process can be effectively radiated and a cutting fluid can be flowed smoothly.

### BACKGROUND

In general, in the turning machining processes such as an outer-diameter turning process, a face turning process and a boring process, heat generated from a workpiece made of stainless steel or inconel is not transferred easily to chips and remains in a cutting insert. As a result, there is a problem that a service life time of a cutting tool is rapidly reduced by the heat that remains.

FIG. 1 is a perspective view of a conventional tool holder utilized for a cutting machining process, a tool holder 10 for a cutting machining comprises a hardmetal shim 15, a pocket 12 with pocket walls 13 to which a cutting insert 20 is mounted and a shank part 11.

During a turning machining process utilizing the cutting insert 20 mounted to the tool holder 10 for a cutting machining process as described above, a chip is developed in a peripheral portion of a workpiece and extends obliquely upwards from the cutting edge of the cutting insert 20. The actual cutting of the chip takes place in a primary shear zone of the cutting insert 20.

Due to excessive friction between the cutting insert 20 and chip generated on the rotating metal workpiece, considerable amounts of heat are generated. This heat is not radiated out of the cutting insert, but instead remains in the cutting insert.

By virtue of the heat that remains in the cutting insert, the cutting insert 20 can easily deteriorate, so the heat causes a reduction of service life time of the cutting insert 20 as well as a lowering of a machining quality.

Accordingly, a cutting insert being capable of preventing a strength of cutting edges from being weakened and having a large surface area by which heat can be effectively radiated is desirable.

In addition, a cutting insert capable of inducing a smooth flow of cutting fluid to maximize a cooling effect and maximizing a surface area of a region to be contacted with a tool holder to perform a stable cutting machining process is also desirable.

### SUMMARY

A cutting insert comprises an upper face and a lower face being opposite to each other, a plurality of side faces connecting the upper face and the lower face and a through hole passing through the upper face and the lower face, the upper face being divided into a peripheral region disposed adjacently to cutting edges formed by the upper face and the side faces, and a central protruded region disposed between the through hole and the periphery region and surrounding the through hole, the central protruded region being placed higher than the edges.

Here, the periphery region is formed along all the cutting edges and comprising an descent face inclined downward from the cutting edge to the central protruded region and an ascent face inclined upward toward the central protruded region, and a plurality of grooves are formed on the central protruded region of the upper face, the grooves being formed such that opposite ends of each groove are directed to adjacent cutting edges.

On the other hand, the periphery region may further comprise a bottom face formed between the descent face and the ascent face, and the groove can be extended to the ascent face and the bottom face of the periphery region. Also, it is preferable that the groove has a width which is smaller than a distance between the neighboring grooves.

It will be apparent that the lower face is the same as the upper face in the configuration.

The cutting insert according to the present invention may be capable of radiating heat without weakening the strength of the cutting edges.

In addition, the cutting insert according to the present invention may be capable of inducing a smooth flow of cutting fluid.

### BRIEF DESCRIPTION OF THE DRAWINGS

FIG. 1 is a perspective view of a conventional tool holder utilized for a cutting machining process.

FIG. 2 is a perspective view of a cutting insert according to the first embodiment of the present invention.

FIG. 3 is a sectional view taken along the line A-A of FIG. 2.

FIG. 4 is a sectional view taken along the line B-B of FIG. 2.

FIG. 5 is a perspective view of a cutting insert according to the second embodiment of the present invention.

FIG. 6 is a sectional view taken along the line C-C of FIG. 5.

FIG. 7 is a sectional view taken along the line D-D of FIG. 5.

### DETAILED DESCRIPTION

Hereinafter, a cutting insert according to the preferred embodiment of the present invention is described in detail with reference to the accompanying drawings.

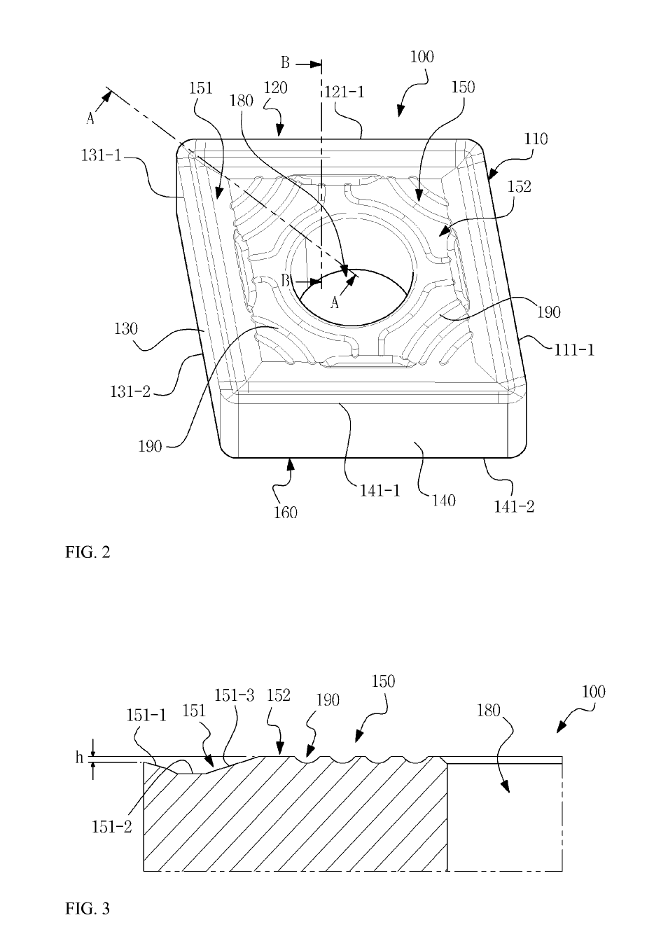

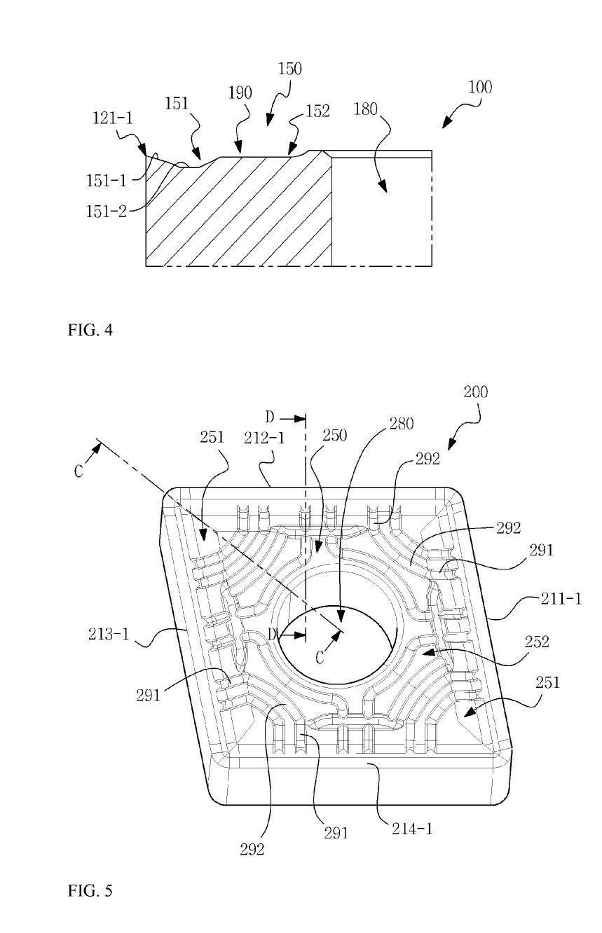

FIG. 2 is a perspective view of a cutting insert according to the first embodiment of the present invention, FIG. 3 is a sectional view taken along the line A-A of FIG. 2 and FIG. 4 is a sectional view taken along the line B-B of FIG. 2. For simplifying the drawings, only upper face of the insert is illustrated in FIG. 3 and FIG. 4.

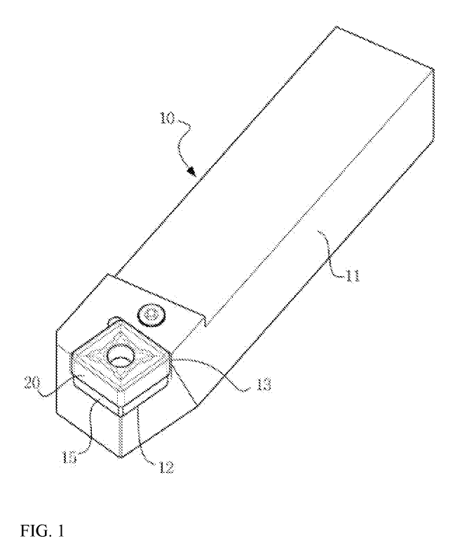

A cutting insert 100 according to the first embodiment of the present invention has an upper face 150 and a lower face 160 being opposite to each other, four (4) side faces 110, 120, 130 and 140 connecting the upper face 150 and the lower face 160. Here, a through hole 180 passes through each central part of the upper face 150 and the lower face 160 and acts as a clamping hole into which a lever or a clamping screw (not shown) is screwed when the cutting insert 100 is mounted to a tool holder (10 in FIG. 1) for a cutting machining

The upper face 150 and the lower face 160 are flat faces placed on a pocket of the tool holder and are substantially parallel with each other. Also, four side faces 110, 120, 130 and 140 of the cutting insert 100 are normal to the upper face 105 and the lower face 106. Here, upper and lower ends 111-1, 121-1, 131-1, 141-1 and 131-2, 141-2 (here, lower ends of side faces 110, 120 are not shown in the drawings) of four side faces 110, 120, 130 and 140 act as main cutting edges (hereinafter, the, upper and lower ends 111-1, 121-1, 131-1, 141-1 and 131-2, 141-2 are referred to as “cutting edges”).

In the meantime, the upper face 150 is divided into a periphery region 151 adjacent to the cutting edges 111-1, 121-1, 131-1 and 141-1 and a central protruded region 152 disposed between the through hole 180 and the periphery region 151 and surrounding the through hole 180.

The periphery region 151 is formed along all the cutting edges 111-1, 121-1, 131-1 and 141-1 and may comprise an descent face 151-1 inclined downward from near each of the cutting edges 111-1, 121-1, 131-1 and 141-1 toward the central protruded region 152, a bottom face 151-2 and an ascent face 151-3 inclined upward toward the central protruded region 152. In some embodiments, the length of the bottom face may be very short, and so the descent face may transition into the ascent face to form a periphery region having a V-shaped cross-section adjacent an associated cutting edge.

As shown in FIG. 2, FIG. 3 and FIG. 4, the central protruded region 152 is placed higher than the edges 111-1, 121-1, 131-1 and 141-1 (“h” in FIG. 2). That is, a thickness between the central protruded region 152 formed on the upper face 150 and the lower face 160 is larger than a thickness between the cutting edge (for example, 111-1) formed on the upper face 150 and the cutting edge (for example, 111-2) formed on the lower face 160.

In the cutting insert 100 according to the first embodiment of the present invention, a plurality of grooves 190 are formed on the central protruded region 152 on the upper face 150 surrounding the through hole 180. The plurality of grooves 190 increases the surface area of the central protruded region 152. The enhanced surface area of the central protruded region 152 is considerably larger than the surface area of similarly sized flat region. This increased surface area helps with heat removal.

In the cutting machining process, most of chips generated on a workpiece come into contact with the ascent face 151-3 of the cutting insert 100. In particular, the chips come into close contact with an end portion of the ascent face 151-3 (that is, an initiating portion of the central protruded region 152). Due to a friction caused by the above contact between the chip and the ascent face 151-3, considerable amounts of heat are generated on the cutting insert.

However, the heat generated as described above is effectively radiated out of the cutting insert 100 through the central protruded region 152 whose surface area is remarkably increased by the grooves 190.

In the present invention, at this time, in order to prevent a flow of chips from being interrupted by the groove and guide smoothly the chips, the grooves are not formed on the ascent face 151-3 and the bottom face 151-2 of the periphery region 151.

If the cutting insert is utilized under the condition in which a flow of the chips is not interrupted by the groove, a shear stress is generated on the chip contacted with an edge of the groove 190, and so the chip can be broken easily into small-sized chip pieces and heat in the chip can be radiated easily out of the cutting insert 100. As shown in FIG. 5 described later, it is more preferable to form grooves 291 on an ascent faces 251-3 and a bottom face 251-2 of a periphery region 251.

A depth and a location of each of the grooves 190 formed on the central protruded region 152 are not limited. As shown in FIG. 2, however, it is preferable that the grooves 190 are uniformly disposed on the central protruded region 152 surrounding the through hole 180 in order to radiate the heat more effectively.

In addition, as shown in FIG. 2 and FIG. 3, a plurality of grooves 190 are formed on only the central protruded region 152, and no groove is formed on the periphery region 151 adjacent to the cutting edges 111-1, 121-1, 131-1 and 141-1. In the cutting insert 100 having the above structure, while the cutting edges 111-1, 121-1, 131-1 and 141-1 to which a cutting force is exerted have a sufficient strength, a heat-radiating effect (i.e., cooling effect) can be maximized.

On the other hand, when the upper face 150 is placed in a pocket of the tool holder, if the upper face 150 is not flat or micro protrusions and recesses are formed on the upper face 150, the cutting insert 100 coupled to the tool holder through a clamping screw can be shaken in the pocket of the tool holder. In a case where the cutting insert 100 is shaken (vibrated) in the pocket due to the above conditions, it may be difficult to precisely machine the workpiece.

A plurality of grooves 190 which are not in contact with a bottom surface of the pocket of the tool holder can minimize an influence caused by a partial non-flat upper face 150 or the micro protrusions/recesses formed on the upper face. Consequently, it is possible to maximize a contact between the bottom surface of the pocket of the tool holder and the upper face 150.

Here, if the groove 190 has an excessive width, the strength of the cutting insert 100 may be reduced. Accordingly, it is desirable that a width of the groove 190 is less than a distance between the adjacent two grooves 190.

Under the above condition, a greater number of grooves 190 can be formed on the central protruded region 152 of the upper face 150 having a limited surface area so that a cooling effect can be maximized.

Here, as shown in FIG. 2 and FIG. 3, each groove 190 is formed such that opposite ends of the groove are directed to the periphery region 151 at sections neighboring adjacent cutting edges 111-1, 121-1, 131-1 and 141-1. Thus, opposite ends of a given groove terminate in adjacent periphery sections associated with corresponding adjacent cutting edges.

Due to the above structure, cutting fluid supplied to both ends of each groove 190 is distributed on the edge perpendicular to a surface of the workpiece and flows toward the cutting edge (for example, 111-1 and 112-1) which is in contact with the workpiece, and so the cooling effect for a friction heat can be maximized by the cutting fluid.

Chips generated from the workpiece by a contact between the cutting edge 111-1, 121-1, 131-1 or 141-1 and the workpiece move along the ascent face 151-3 of the periphery region 151, and a shear stress is generated on the chip which has reached a border portion between the groove 190 and the ascent face 151-3 of the periphery region 151. Accordingly, numerous corrugations are formed on a chip which has reached an area of the periphery at which the grooves 190 begin so that the chip can be broken easily into small-sized chip pieces.

Thus, a method of forming chips cut from a workpiece includes providing a cutting tool having a cutting insert of the sort disclosed herein, cutting the workpiece to create chips having a plurality of spaced apart corrugations formed on the underside of the chips, with spacings between the corrugations corresponding to spacings between adjacent groove ends, thereby facilitating breaking of the chips.

In addition, a function of the cutting fluid flowed in the groove 190 as described above is to eliminate a resistance factor having an effect on a discharge of the chip, and so it is possible to increase a service life time of the cutting insert 100 and obtain a machined article having excellent quality.

As described above, on the other hand, since the central protruded region 152 is placed higher than the cutting edges 111-1, 121-1, 131-1 and 141-1, when the upper face 150 is mounted to the pocket, the central protruded region 152 of the upper face 150 is in contact with a bottom face of the pocket while the cutting edges 111-1, 121-1, 131-1 and 141-1 is not contacted with the bottom face of the pocket. As a result, the cutting insert is mounted stably to the pocket while a damage of the cutting edges 111-1, 121-1, 131-1 and 141-1a can be prevented.

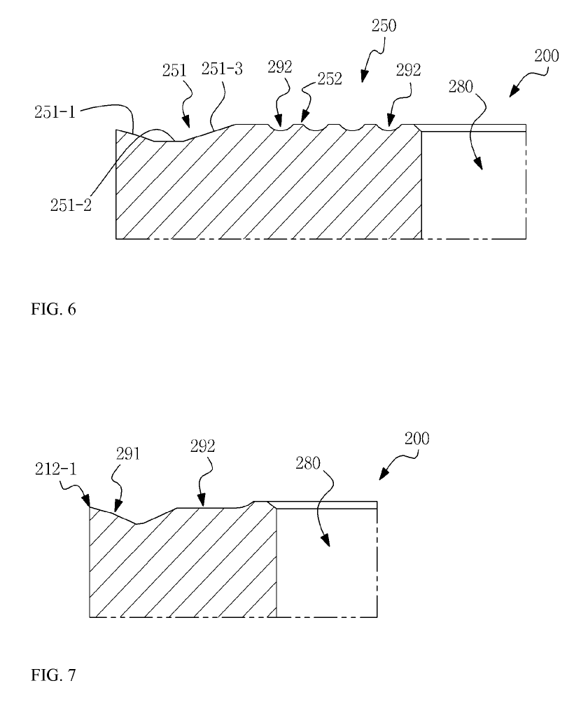

FIG. 5 is a perspective view of a cutting insert according to the second embodiment of the present invention, FIG. 6 is a sectional view taken along the line C-C of FIG. 5 and FIG. 7 is a sectional view taken along the line D-D of FIG. 5.

The overall structure of the cutting insert 200 according to the second embodiment is the same as that of the cutting insert 100 according to the first embodiment shown in FIG. 2, FIG. 3 and FIG. 4.

In the cutting insert 100 according to the first embodiment, the grooves 190 are formed on only the central protruded region 152 of the upper face 150. In the cutting insert 200 according to the second embodiment, however, each groove includes at least one first groove portion 291 formed on at least a portion of the periphery, and a second groove portion formed on the central protruded region. Thus, a plurality of first and second groove portions 291 and 292 are formed on the upper face 250, which includes a periphery region 251 (in particular, a bottom face 251-2 and an ascent face 251-3) adjacent to cutting edges 211-1, 212-1, 213-1 or 214-1 and a central protruded region 252 disposed between the periphery region 251 and a through hole 280 and surrounding the through hole 280.

Each first groove portion 291 has an outer end that is close to a corresponding cutting edge and an inner end which is away from that cutting edge. Here, it is preferable that each end of the second groove portion 292 formed on the central protruded region 252 communicates with the outer end of one of the first groove portions 291 formed on the periphery region 251. The other ends (i.e., the inner ends which do not communicate with the second groove portion 292) of the two first groove portions 291 are proximate the adjacent cutting edge 211-1, 212-1, 213-1 or 214-1.

In the cutting insert 200 according to this embodiment, the first groove portion 291 generally is not formed on the descent face 251-1 of the periphery region 251. In other words, the first groove portion 291 is formed on a bottom face and the ascent face of the periphery region 251 adjacent to the cutting edge 211-1, 212-1, 213-1 or 214-1 and the inner end of the first groove portion 291 communicates with the second groove portion 292 of the central protruded region 252. Thus, in the second embodiment, the groove extends to the ascent face and the bottom surface of the periphery region 251 proximate to adjacent cutting edges.

As described above, except at the cutting edges 211-1, 212-1, 213-1 or 214-1 which are most vulnerable areas in the cutting insert 200, and the decent faces 251-1 of the periphery region 251, the grooves in the second embodiment are formed on all regions. Due to the above structure, the cooling effect obtained by the grooves can be maximized without weakening the strength of the cutting edges 211-1, 212-1, 213-1 or 214-1.

Here, a function of respective groove in the second embodiment is the same as those of groove 190 formed on the upper face 150 of the cutting insert 100 according to the first embodiment. Accordingly, the detail description thereon is omitted.

In other words, although the cutting inserts 100 and 200 having the structure in which the grooves 190, and groove portions 291 and 292 are formed on the upper faces 150, 250 are illustrated herein, the present invention is not limited thereto. That is, it will be apparent that the lower face (for example, 160 in FIG. 2) has a structure which is the same as that of the upper face (for example, 150 in FIG. 2) in order to utilize the edges (for example, 111-2, 131-2, 141-2 in FIG. 2 and FIG. 3) of the lower face (for example, 160 in FIG. 2) as well as the edges (for example, 111-1, 121-1, 131-1, 141-1 in FIG. 2) of the upper face (for example, 150 in FIG. 2) as the cutting edges.

Also, as seen in both FIGS. 2 and 5, for a given pair of adjacent cutting edges (e.g., 121-1 and 131-1 in FIGS. 2; 212-1 and 213-1 in FIG. 2) there can be a plurality of grooves having opposite ends directed to the adjacent cutting edges.

The scope of the present invention is not limited to the embodiments described above and the scope of the present invention is determined and defined only by the appended claims. Further, those skilled in the art can make various changes and modifications thereto without departing from its true spirit. Therefore, various changes and modifications obvious to those skilled in the art will fall within the scope of the present invention.

What is claimed is:

1. A cutting insert, comprising:
an upper face, a lower face, a plurality of side faces connecting the upper face and the lower face, and a through hole passing through the upper face and the lower face,
the upper face being divided into a periphery region disposed adjacently to cutting edges formed by the upper face and the side faces and a central protruded region disposed between the through hole and the periphery region and surrounding the through hole, the central protruded region being placed higher than the cutting edges,
the periphery region being formed along all the cutting edges and comprising a descent face inclined downwardly from a given cutting edge in a direction of the central protruded region and an ascent face inclined upwardly in the direction of the central protruded region,
a plurality of grooves being formed on the central protruded region of the upper face, the grooves being formed such that opposite ends of each groove are directed to adjacent cutting edges.

2. The cutting insert according to claim 1, wherein the periphery region further comprises a bottom face formed between the descent face and the ascent face, and each groove extends to the ascent face and the bottom face of the periphery region.

3. The cutting insert according to claim 2, wherein each groove does not extend to the descent face.

4. The cutting insert according to claim 2, wherein, for a given pair of adjacent cutting edges, there are a plurality of grooves having opposite ends directed to the adjacent cutting edges.

5. The cutting insert according to claim 4, wherein each of the plurality of grooves has a width which is smaller than a distance between neighboring grooves.

6. The cutting insert according to claim 1, wherein the lower face is the same as the upper face in the configuration.

7. The cutting insert according to claim 1, wherein each groove extends to the ascent face but not to the descent face.

8. The cutting insert according to claim 1, wherein, for a given pair of adjacent cutting edges, there are a plurality of grooves having opposite ends directed to the adjacent cutting edges.

9. The cutting insert according to claim 8, wherein each of the plurality of grooves has a width which is smaller than a distance between neighboring grooves.

10. A method of forming chips cut from a workpiece comprising:
providing a cutting tool having a cutting insert in accordance with claim 1, and
cutting the workpiece with the cutting tool to create chips having a plurality of spaced apart corrugations formed on an underside of the chips, with spacings between the corrugations corresponding to spacings between adjacent groove ends.
